(19) United States
(12) Patent Application Publication
(10) Pub. No.: US 2020/0218131 A1
(43) Pub. Date: Jul. 9, 2020

(54) LENS SCREENING DEVICE

(71) Applicant: FUNDER ELECTRONIC GLOBAL CO., LTD., Taipei City (TW)

(72) Inventor: Wai-How Weng, Taipei City (TW)

(21) Appl. No.: 16/243,053

(22) Filed: Jan. 8, 2019

(51) Int. Cl. G03B 11/04; H01F 7/08; H01F 7/06; H01F 27/28; H01F 27/24

(52) U.S. Cl. CPC G03B 11/041; H01F 7/081; H01F 27/24; H01F 27/28; H01F 7/064

(57) ABSTRACT

A lens screening device includes a hollow housing, the top and bottom surfaces of which respectively have a corresponding through hole; the housing defines an accommodation space, inside which a shaft is configured, and the shaft is configured with a magnetic element, the top surface of which is in combination with a plate body, another end of which is positioned between the through holes; the two ends of the magnetic element respectively are a positive pole and negative pole; the two sides of the magnetic element are respectively configured with an iron core, the bottoms of the two iron cores are in connection with each other, the two iron cores are respectively configured with a first coil and second coil respectively in connection with a positive lead and negative lead; the first coil is adjacent to the positive pole, and the second coil the negative pole.

### (a) TECHNICAL FIELD OF THE INVENTION

The present invention relates to a lens screening device, and more particularly to a lens screening device using a plate body to expose a lens after the plate body is swung, preventing camera shooting from being carried out without consent, thereby protecting privacy.

### (b) DESCRIPTION OF THE PRIOR ART

The camera lenses of general electronic products provided with image pickup and network communication functions such as smart phones are mainly turned on or off through microprocessors. But, because of the madness of internet hackers, the network communication modules of the electronic devices are still probably invaded by the hackers to control the microprocessors to open camera lenses to carryout image pickup and then to take picture of user' privacy in secret without users' knowledge even if the camera lenses are closed in the first place. Furthermore, when the electronic products mentioned above are used in video communication, the camera lens will be turned on automatically to carry out image pickup once the user pick up a telephone, making the user have to disclose the image of their location and unable to protect personal privacy.

### SUMMARY OF THE INVENTION

To overcome the defects mentioned above, the present invention proposes a lens screening device, comprising: a housing, a top surface and bottom surface thereof respectively having a corresponding through hole, an inside of the housing having an accommodation space in communication with the through holes, and an inside of the accommodation space configured with a shaft configured with a magnetic element; and a plate body, one end thereof in combination with a top surface of the magnetic element and another end thereof positioned between the through holes, two ends of the magnetic element being respectively a positive pole and negative pole, two sides of the magnetic element respectively configured with an iron core, the two iron cores spaced an interval, two bottoms of the iron cores in connection with each other, the two iron cores respectively configured with a first coil and second coil, the first coil and second coil respectively in connection with a positive lead and negative lead, the first coil adjacent to the positive pole, the second coil the negative pole, another end of the positive lead and negative lead in combination with a terminal in electric connection with an external power source, and the first coil and second coil respectively magnetically repelled with the positive pole and negative pole after power is on, allowing the magnetic element to be rotated to drive the plate body to move so as to expose the through holes.

### BRIEF DESCRIPTION OF THE DRAWINGS

FIG. 1 is a perspective view of the present invention;

FIG. 2 is an exploded view of the present invention;

FIG. 3 is a schematic view of the present invention in a screening state;

FIG. 4 is a schematic view of the present invention when a lens is not screened; and

FIG. 5 is an exploded view of another preferred embodiment of the present invention.

### DETAILED DESCRIPTION OF THE PREFERRED EMBODIMENTS

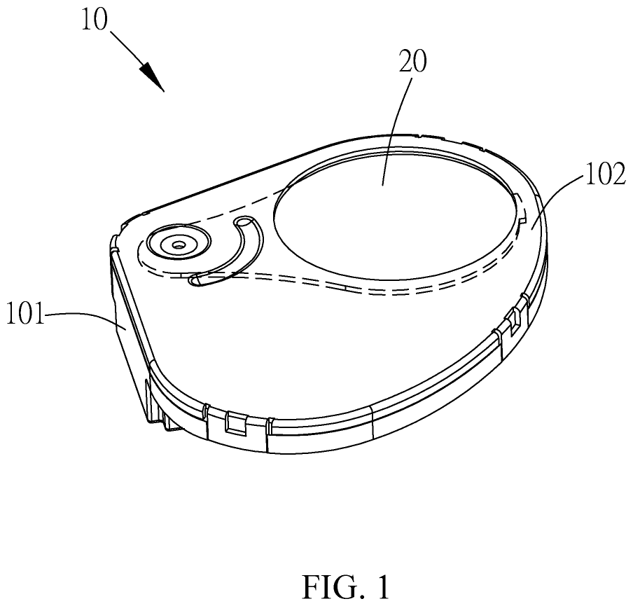

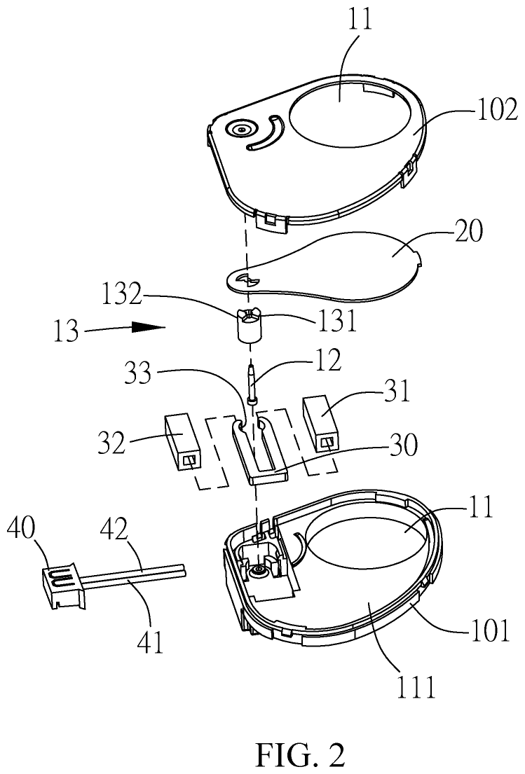

Referring to FIGS. 1 and 2, a lens screening device of the present invention includes a housing 10, the top surface and bottom surface of which respectively have a corresponding through hole 11, where the housing 10 is a fan-shaped body and includes a lower shell 101 and upper shell 102, with the through hole 11 being respectively configured on the lower shell 101 and upper shell 102.

The inside of the housing 10 has an accommodation space 111 in communication with the through holes 11, the accommodation space 111 is configured inside with a shaft 12 configured with a magnetic element 13, the two ends of which respectively are a positive pole 131 and negative pole 132.

The lens screening device of the present invention also includes a plate body 20, and one side of the plate body 20 is in combination with the top surface of the magnetic element 13 and another end thereof is positioned between both the through holes 11.

The two sides of the magnetic element 13 are respectively configured with a iron core 30, where the iron cores 30 are spaced apart and the bottoms thereof are in combination with each other; a first coil 31 is configured on one of the iron core 30 and a second coil 32 on another iron core 30; the top ends of the cores 30 are respectively configured with a concave portion 33 respectively facing the position pole 131 and negative pole 132.

The first coil 31 and second coil 32 are respectively in connection with a positive lead 41 and negative lead 42; the first coil 31 is adjacent to the positive pole 131, and the second coil 32 the negative pole 132; other ends of the positive lead 41 and negative lead 42 are respectively in combination with a terminal 40 in connection with an external power source (not shown in the figures).

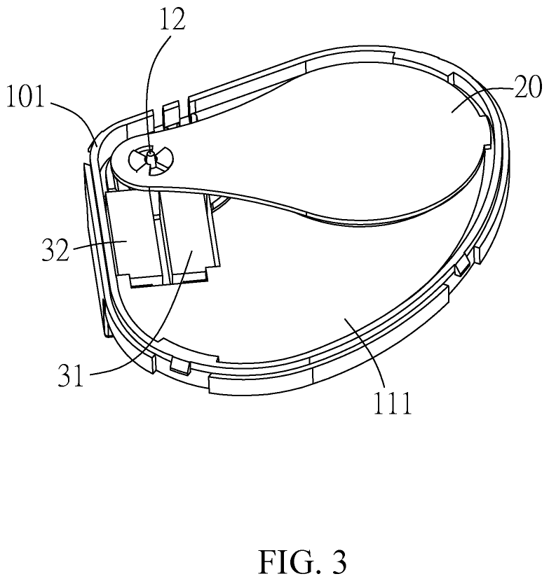

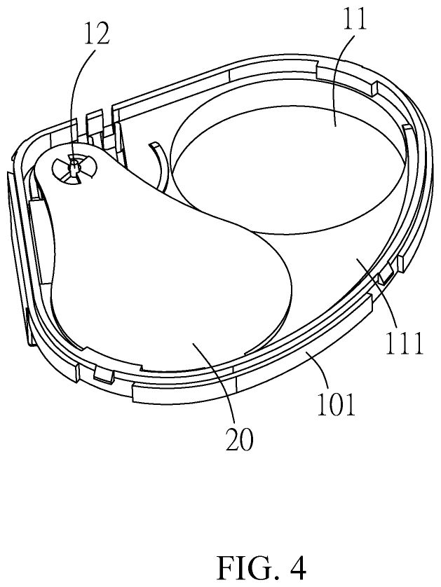

Referring to FIGS. 3 and 4, the first coil 31 and second coil 32 are respectively magnetically repelled with the positive pole 131 and negative pole 132, allowing the magnetic element 13 to be rotated to drive the plate body 20 to move so as to expose each through hole 11.

The lens screening device of the present invention can be installed on a smart phone and each through hole 11 is used to be correspondingly in combination with the lens of the phone. Furthermore, the terminal 40 is then in electric connection with the phone, and the operation timing and other functions of the lens screening device of the present invention can be set through the programs inside the phone.

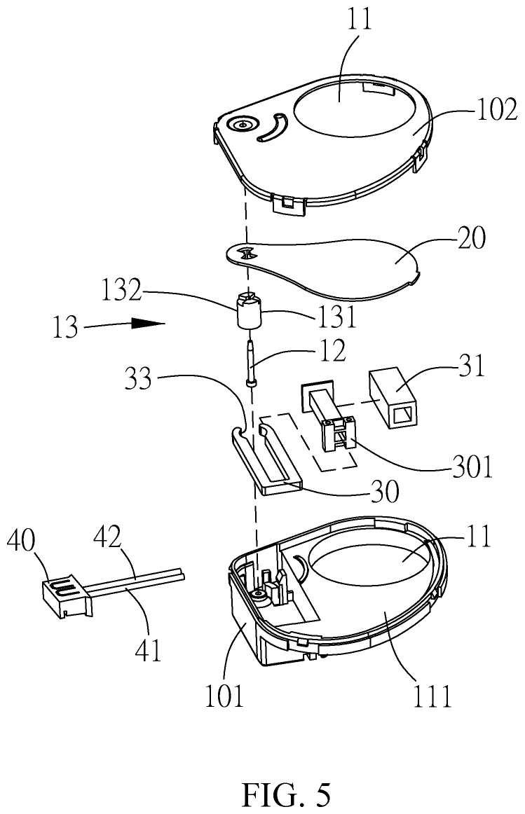

Referring to FIG. 5, showing another preferred embodiment of the present invention, the present embodiment is almost similar to the above embodiment except that one of the iron cores 30, in the present embodiment, is configured with a coil bracket 301 configured with a first coil 31, the two ends of which are respectively in connection with a positive lead 41 and negative lead 42, where the first coil 31 is adjacent to the positive pole 131, another end of the positive lead 41 and negative lead 42 is in combination with a terminal 40 in electric connection with an external power source; the magnetic element 13 is caused to be rotated to drive the plate body 20 to move so as to expose through holes 11 through the magnetic repel between the first coil and positive pole 131 after power is on.

1. A lens screening device, comprising:
a housing, a top surface and bottom surface thereof respectively having a corresponding through hole, an inside of said housing having an accommodation space in communication with said through holes, and an inside of said accommodation space configured with a shaft configured with a magnetic element; and
a plate body, one end thereof in combination with a top surface of said magnetic element and another end thereof positioned between said through holes, two ends of said magnetic element being respectively a positive pole and negative pole, two sides of said magnetic element respectively configured with an iron core, said two iron cores spaced an interval, two bottoms of said iron cores in connection with each other, said two iron cores respectively configured with a first coil and second coil, said first coil and second coil respectively in connection with a positive lead and negative lead, said first coil adjacent to said positive pole, said second coil said negative pole, another end of said positive lead and negative lead in combination with a terminal in electric connection with an external power source, and said first coil and second coil respectively magnetically repelled with said positive pole and negative pole after power is on, allowing said magnetic element to be rotated to drive said plate body to move so as to expose said through holes.

2. Said device according to claim 1, wherein a top end of each said iron core is configured with a concave portion respectively facing said positive pole and negative pole of said magnetic element.

3. Said device according to claim 1, wherein said housing comprises a lower shell and upper shell.

4. Said device according to claim 3, wherein said housing is a fan-shaped body.

5. A lens screening device, comprising:
a housing, a top surface and bottom surface thereof respectively having a corresponding through hole, an inside of said housing having an accommodation space in communication with said through holes, and an inside of said accommodation space configured with a shaft configured with a magnetic element; and
a plate body, one end thereof in combination with a top surface of said magnetic element and another end thereof positioned between said through holes, two ends of said magnetic element being respectively a positive pole and negative pole, two sides of said magnetic element respectively configured with an iron core, said two iron cores spaced an interval, two bottoms of said iron cores in connection with each other, one of said two iron cores configured with a first coil, two ends of said first coil respectively in connection with a positive lead and negative lead, said first coil adjacent to said positive pole, unsaid end of said positive lead and negative lead in combination with a terminal in electric connection with an external power source, and said first coil magnetically repelled with said positive pole after power is on, allowing said magnetic element to be rotated to drive said plate body to move so as to expose said through holes.

6. Said device according to claim 5, wherein said housing comprises a lower shell and upper shell.

7. Said device according to claim 6, wherein said housing is a fan-shaped body.
